(19) United States
(12) Patent Application Publication
(10) Pub. No.: US 2020/0076995 A1
(43) Pub. Date: Mar. 5, 2020

(54) CAMERA MODULE

(71) Applicants: TRIPLE WIN TECHNOLOGY(SHENZHEN) CO.LTD., Shenzhen (CN); HON HAI PRECISION INDUSTRY CO., LTD., New Taipei (TW)

(72) Inventors: DING-NAN HUANG, New Taipei (TW); CHIA-WEI CHEN, New Taipei (TW); SHIN-WEN CHEN, Tu-Cheng (TW)

(21) Appl. No.: 16/170,535

(22) Filed: Oct. 25, 2018

(30) Foreign Application Priority Data
Sep. 5, 2018 (CN) 201811033519.4

(51) Int. Cl. H04N 5/225

(52) U.S. Cl. CPC H04N 5/2253; H04N 5/2252; H04N 5/2254

(57) ABSTRACT

A camera module with a strong and stable mounting which is geometrically precise includes a printed circuit board, an optical bearing structure, and an image sensor. The printed circuit board includes a mounting surface, the mounting surface defining a conductive circuit area and a surrounding non-conductive peripheral area. The peripheral area comprises a first contact layer, the first contact layer is frame-like and a size of the first contact layer is same as a size of bottom of the optical bearing structure. The optical bearing structure is on the first contact layer and carries a lens module. The image sensor is mounted on the conductive circuit area.

### FIELD

The subject matter herein generally relates to imaging.

### BACKGROUND

A camera module includes a printed circuit board and an optical bearing structure. The printed circuit board is designed to include a plurality of conducting lines, and surface of the printed circuit board is uneven. A printed circuit board cannot be regarded as a strong and precise strong foundation for an imaging element, optical axis of the optical bearing structure is easily tilted, and shooting quality of the camera module will not be optimal.

Therefore, there is room for improvement in the art.

### BRIEF DESCRIPTION OF THE DRAWINGS

Implementations of the present technology will now be described, by way of example only, with reference to the attached figures.

FIG. 1 is an assembled isometric view of a camera module in accordance with one embodiment.

FIG. 2 is an exploded isometric view of the camera module in FIG. 1.

FIG. 3 is a top view of a portion of a printed circuit board comprised in the camera module in FIG. 1.

FIG. 4 is a cross-sectional view of a camera module in accordance with one embodiment.

FIG. 5 is a top view of a printed circuit board in accordance with one embodiment.

FIG. 6 is an exploded isometric view of a camera module in accordance with one embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but it can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

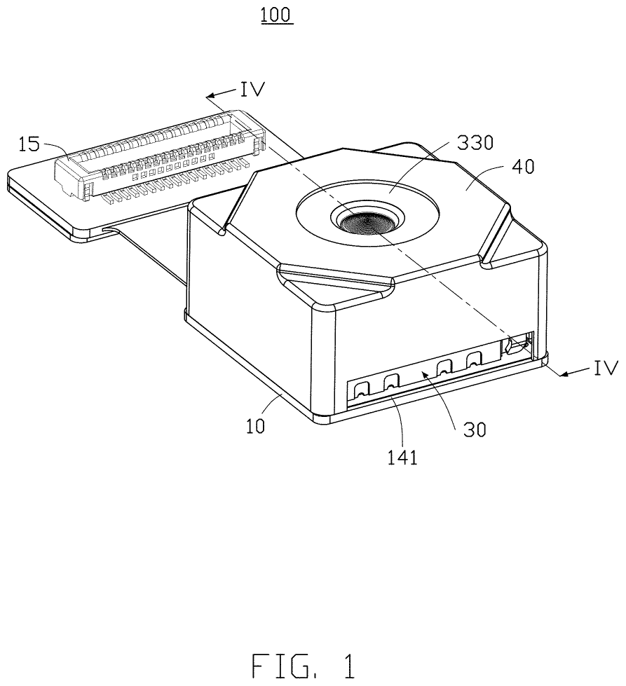

FIG. 1 illustrates a camera module 100 according to one embodiment. The camera module 100 is a zoom lens module and includes a printed circuit board 10, an imaging sensor 20, an optical bearing structure 30, and a metal housing 40.

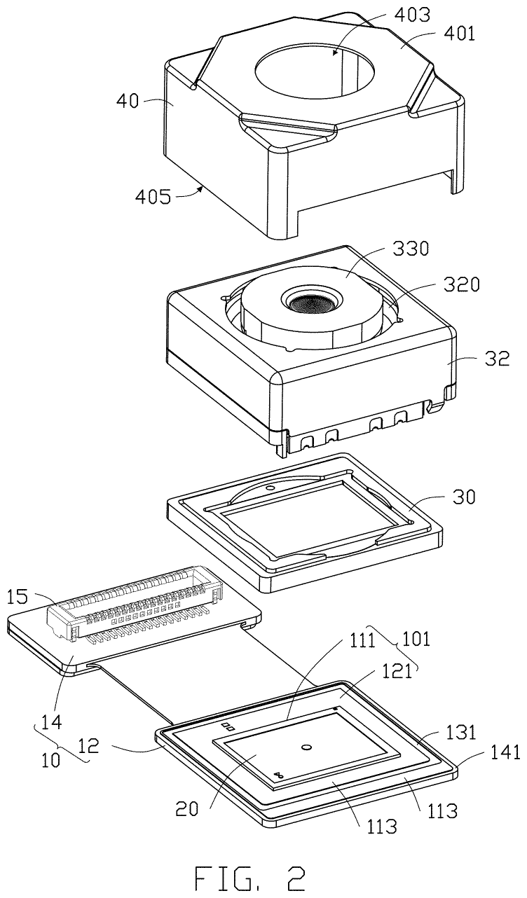

The printed circuit board 10 can be a flexible circuit board, a rigid board, or a rigid-flexible board. In the shown embodiment, the printed circuit board 10 is a rigid board. The printed circuit board 10 includes a main portion 12 and an extending portion 14 connecting to the main portion 12, as shown in FIG. 2. The main portion 12 is configured to bear the image sensor 20 and the optical structure 30. The extending portion 14 is configured to carry connectors 15. The connectors 15 are electrically connected to the image sensor 20 and configured to transmit commands and signals between the optical projector module 100 and an external electrical device.

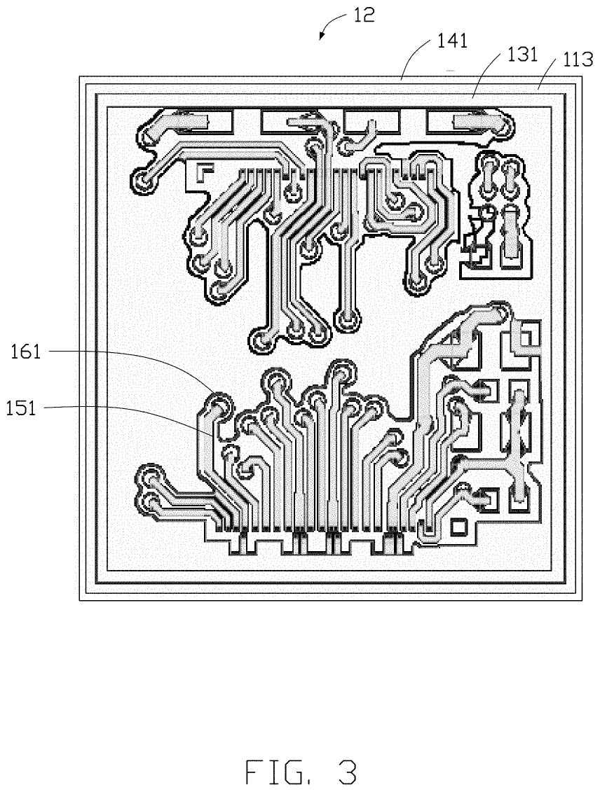

The main portion 12 includes a mounting surface 101. The mounting surface 101 defines a conducting circuit area 111 in the center and a peripheral area 121 surrounding the conducting circuit area 111. The conducting circuit area 111 is provided with a plurality of conductive circuits 151 and conductive holes 161, as shown in FIG. 3. FIG. 3 illustrates the conductive circuits 151 and conductive holes 161, the conductive lines 151 and conductive holes 161 enable functionality of the lens module. A solder mask layer 113 is formed on the conducting circuit area 111 for protecting the plurality of conductive lines and the conductive holes.

The peripheral area 121 includes a first contact layer 131 and a second contact layer 141 spaced apart from the first contact layer 131. Material of the first contact layer 131 and the second contact layer 141 are metal. Spacing between the first contact layer 131 and the second contact layer 141 also is formed by a solder mask layer 113. That is, there are no conductive lines arranged in the periphery area 121. A method to form the first contact layer 131 and the second contact layer 141 is same for the conductive lines 151. In other embodiments, the first contact layer 131 can be a solder mask formed on an insulating layer of the printed circuit board 10.

The first contact layer 131 is a frame-like structure and a size of the first contact layer 131 is same as a size of bottom of the optical bearing structure 30. In the embodiment, the first contact layer 131 is a closed frame structure. The second contact layer 141 is a closed frame structure and the second contact layer 141 is electrically connected to ground.

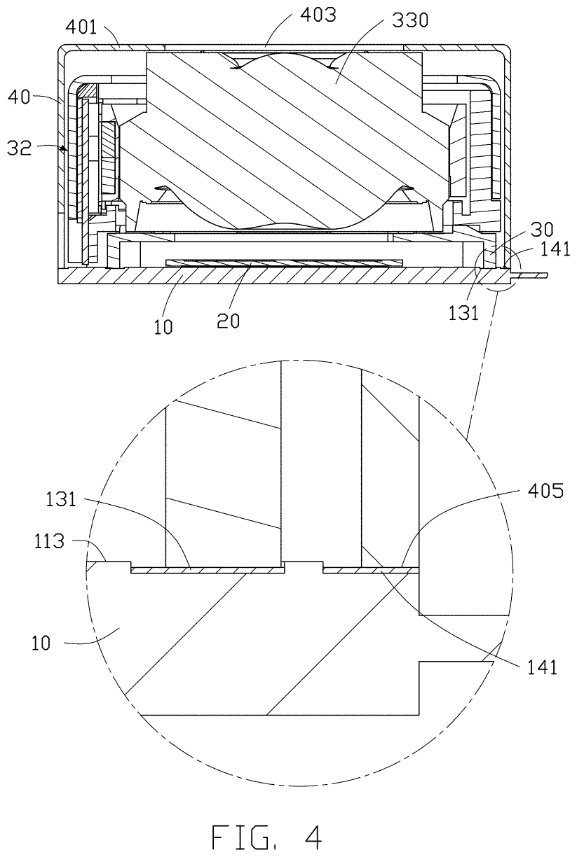

A surface of the first contact layer 131 and a surface of the second contact layer 141 are lower than a surface of the solder mask layer 113, as shown in FIG. 4. The first contact layer 131 and the second contact layer 141 are formed at the same time as the conductive lines, the solder mask layer 113 is formed afterwards. Thereby, the solder mask layer 113 protrudes from the first contact layer 131 and the second contact layer 141.

The image sensor 20 is mounted on the conducting circuit area 111 and electrically connected with the conducting circuit area 111 (not shown). The imaging sensor 20 may be a charge-coupled device or a complementary metal oxide semiconductor. The imaging sensor 20 can be a CSP (Chip Scale Package) type image sensor or a COB (Chip On Board) type image sensor.

In the embodiment, the frame-like optical bearing structure 30 is substantially square and is made of plastic material. The optical bearing structure 30 is configured for supporting a voice coil motor 32. The optical bearing structure 30 is mounted on the first contact layer 131. The optical bearing structure 30 may be fixed on the surface of the first ground metal layer 131 by a colloid adhesive. A width of the first contact layer 131 is not less than a bottom width of the optical bearing structure 30, to ensure flatness of the optical bearing structure 30. The first contact layer 131 is located on the periphery area 121, and the periphery area 121 is without conductive circuit. The smoothness of the first contact layer 131 is likely improved, the optical bearing structure 30 is smooth when installed, and when the voice coil motor 32 is fixed into the optical bearing structure 30, an optical axis of the voice coil motor 32 is not tilted.

The voice coil motor 32 is assembled into the optical bearing structure 30. The voice coil motor 32 includes a receiving space 320 for receiving a lens module 330. The printed circuit board 10 controls the voice coil motor 32 to move the lens module 330 for focusing or zoom operations.

The metal housing 40 is fixed on the second ground metal layer 141. The metal housing 40 includes a top plate 401 and a side wall 404 perpendicularly extending from edges of the top plate 401. The top plate 401 defines a through hole 403 to allow light to enter the lens module 330. The side wall 404 includes a bottom end 405 opposite to the top plate 401. The bottom end 405 can be fixed on the second ground metal layer 141 by soldering to connect the metal shell 40 to ground. Thus, the metal housing 40 conducts any electromagnetic interference generated by the voice coil motor 32 to ground to eliminate electromagnetic interference. The metal housing 40 also shields against external signals and electromagnetic interference generated externally which might otherwise interfere with the operation of the camera module 100.

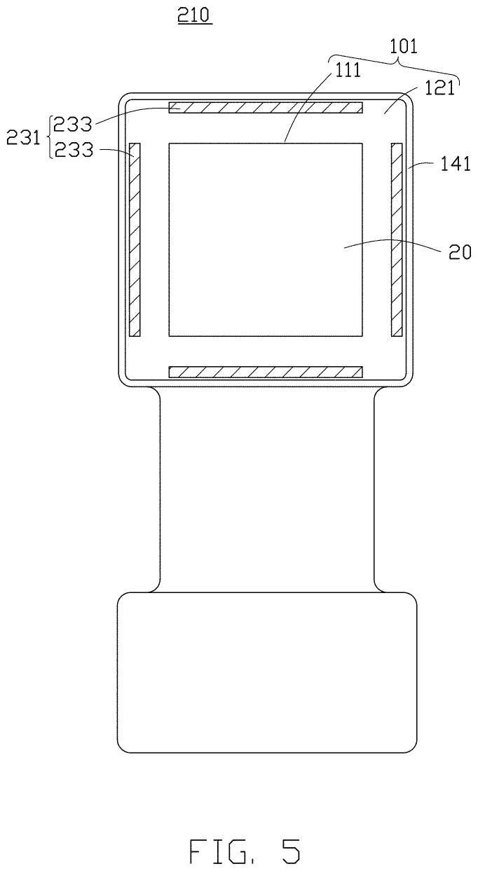

FIG. 5 shows a printed circuit board 210 according to another embodiment. The printed circuit board 210 in FIG. 4 is similar to the printed circuit board 10 in FIG. 2. The printed circuit board 210 also includes a mounting surface 101, the mounting surface 101 includes a conducting circuit area 111 and a peripheral area 121 surrounding the conducting circuit area 111. The image sensor 20 is mounted on the conducting circuit area 111, and the peripheral area 121 is provided with a first ground metal layer 231 and a second contact layer 141 surrounding the first ground metal layer 231. The difference between the printed circuit board 210 and the printed circuit board 10 in FIG. 2 is that the first contact layer 131 includes a plurality of metal strips 233, the contours of the metal strips 233 being the same as the bottom of the optical bearing structure 40. In the embodiment, the first contact layer 131 includes four metal strips 233. Each metal strip 233 is arranged to be adjacent to a side edge of the printed circuit board 210. A width of each metal strip 233 is not less than a bottom width of the optical bearing structure 30.

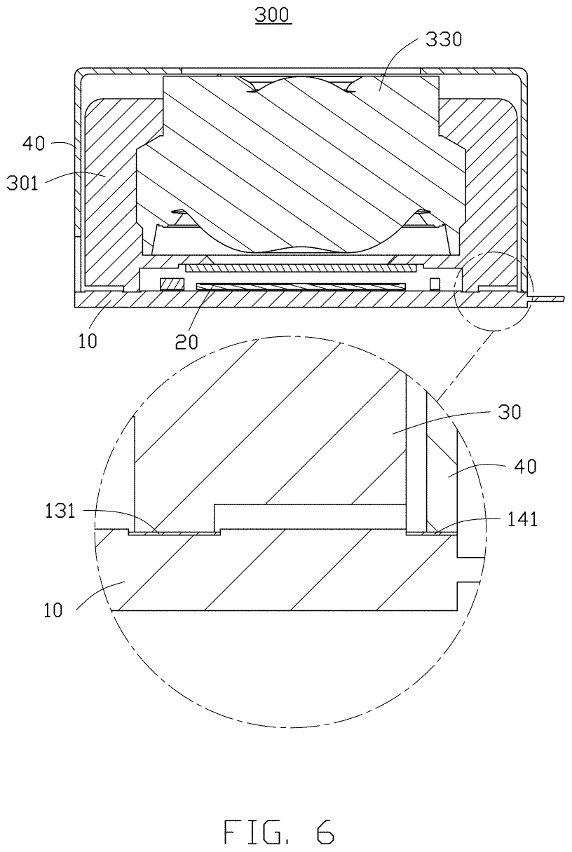

FIG. 6 shows a camera module 300 according to another embodiment. The camera module 300 in FIG. 5 is similar to the camera module 100 in FIG. 2. The difference between the camera module 300 and the camera module 100 in FIG. 3 is that the camera module 300 is a fixed focus lens module. The optical bearing structure 301 is a lens holder, simply receiving the lens module 330. The metal housing 40 is fixed on the second contact layer 141 and configured to cover the optical bearing structure 301. A shielding structure formed by the metal shell 40 and the second contact layer 141 prevents external noise from interfering with the signals of the image sensor 20.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A camera module comprising:
a printed circuit board comprising a mounting surface, which defining a conducting circuit area in the central and a peripheral area surrounding the conducting circuit area, the peripheral area comprises a first contact layer, the first contact layer is a frame structure and a size of the first contact layer is same to a size of bottom of the optical bearing structure;
an optical bearing structure fixed on the first contact layer and configured to bear a lens module; and
an image sensor mounted on the conducting circuit area and configured to receive light from the lens module.

2. The camera module of claim 1, wherein the conducting circuit area is provided with a plurality of conductive circuits and conductive holes, and a solder mask layer is formed on the conducting circuit area for protecting the plurality of conductive lines and the conductive holes.

3. The camera module of claim 1, wherein the first contact layer is a closed frame structure.

4. The camera module of claim 1, wherein the peripheral area further comprises a second contact layer surrounding the first contact layer, and the second contact layer is a closed frame structure and electrically connected to ground.

5. The camera module of claim 4, wherein the camera module further comprising a metal housing, the metal housing cover the lens module, and the metal housing is fixed on the second ground metal layer.

6. The camera module of claim 1, wherein the first contact layer comprises a plurality of metal strips, and the contours of the plurality of metal strips are the same as the bottom of the optical bearing structure.

7. The camera module of claim 1, wherein a width of the first contact layer is no less than a bottom width of the optical bearing structure.

8. The camera module of claim 5, wherein the metal housing comprises a top plate and a side wall perpendicularly extending from edges of the top plate, the top plate defines a through hole to ensure light enter the lens module, the side wall comprises a bottom end opposite to the top plate, and a width of the second contact layer is no less than a bottom width of the bottom end.

9. The camera module of claim 8, wherein spacing between the first contact layer and the second contact layer is formed with a solder mask layer.

10. The camera module of claim 9, wherein the camera module is a zoom lens module, the optical bearing structure is substantially a square frame and configured to support a voice coil motor, and the lens module is received in the voice coil motor.

11. The camera module of claim 10, wherein the camera module is a fixed focus lens module, the optical bearing structure is a lens holder, and the lens module is received in the lens holder.

12. The camera module of claim 5, wherein the surface of the first contact layer and surface of the second contact layer are lower than surface of the solder mask layer.

13. The camera module of claim 1, wherein the first contact layer is a solder mask layer.
